(19) United States
(12) Patent Application Publication
(10) Pub. No.: US 2013/0124551 A1
(43) Pub. Date: May 16, 2013

(54) OBTAINING KEYWORDS FOR SEARCHING

(71) Applicant: Teck Wee Foo, Eindhoven (NL)

(72) Inventor: Teck Wee Foo, Eindhoven (NL)

(73) Assignee: KONINKLIJKE PHILIPS ELECTRONICS N.V., Eindhoven (NL)

(21) Appl. No.: 13/812,155

(22) PCT Filed: Jul. 21, 2011
(86) PCT No.: PCT/IB2011/053254

§ 371 Date: Jan. 25, 2013

(30) Foreign Application Priority Data
Jul. 26, 2010 (EP) 10170779.2

(51) Int. Cl. G06F 17/30

(52) U.S. Cl. CPC G06F 17/30825
USPC 707/758

(57) ABSTRACT

A playback apparatus (100) and corresponding method for playing back images. The apparatus comprising a controller (110) configured for executing the steps of: recognizing an object in an image being played back (320); obtaining a keyword (410) associated to the recognized object (340); and—searching for information based on the keyword (370).

### BACKGROUND OF THE INVENTION

1. Technical Field

The present invention relates to the field of playing back images and more particularly to obtaining keywords for searching, when the viewer is watching the images.

2. Description of Related Art

When watching a movie through an optical disc like DVD or Bluray, through TV broadcasting or online videos, sometimes, viewers want to find out more about the actors. For example, viewers want to find what other movies the actors acted in, information about their personal life, etc.

With most exisiting playback apparatuses, viewers need to call up information that comes with the Electronic Program Guide (EPG) to find out more about the actors. This service is not available to all type of content and also the provided information is generally limited. Internet connectivity has been included in the most recent generation of TV and Bluray Disc (BD) players, so the search for information may be performed by means of the playback apparatus itself. However, at the very least the viewers need to key in the information they are looking for by using T9-dictionary like editing on the digit keypad of the remote control, or by using a QWERTY keyboard. Regarding this latter option, the advantage of a consumer electronics device over a personal computer is the layback experience of the former. Therefore, it is preferable not having to use a regular PC-like keyboard with a comsumer electronice device.

FIG. 1 shows a snapshot of the functionality ‘MovieIQ’ that has been announced by Sony recently. MovieIQ offers additional information about the movie being played. However, this information is limited and stays the same through the program. US 2008/0059526 A1 discloses a playback apparatus that includes: playback means for playing back a content to display images; extraction means for extracting keywords from subtitles tied to an image being displayed; keyword presentation means for presenting the keywords extracted by the extraction means; and searching means for searching a content on the basis of a keyword selected from the keywords presented by the keyword presentation means.

Generally, subtitles express something related to the contents of an image being displayed, for example the words spoken by an actor in a movie or by a presenter of a program. However, the subtitles generally do not comprise information regarding the actors or the presenter themselves.

### SUMMARY OF THE INVENTION

It would be desirable to enable a viewer to easily perform a search for information associated with objects, for example actors, in an image, which is being played back.

To better address this concern, according to an aspect of the invention a playback apparatus is provided for playing back images, the apparatus comprising a controller configured for executing the steps of: recognizing an object in an image being played back; obtaining a keyword associated to the recognized object; and searching for information based on the keyword. The images may be still images or video frames of video. The objects may be humans appearing in the image, such as actors or presenters, or non-human objects, such as a mobile phone, a diamond ring, etc. The recognition of objects in the image may be performed by means of image recognition techniques, that are known as such. The searching for information associated to an object may be performed by using a search engine for searching the Internet, by searching in locally stored data in a memory of the playback apparatus, etc.

As a result, the viewer is enabled to search for information associated to objects in the image quickly and in a user friendly way.

According to an embodiment of the present invention, the controller is further configured for: obtaining a plurality of keywords and enabling a user to select one of the keywords for searching. By automatically populating a menu list of keywords and giving the viewer the option to select one of them, the searching activity may be performed by the viewer in a manner, which is very appropriate for a consumer electronics, i.e. by simply scrolling through a menu with options with his remote control and selecting the desired option with a conformation button. Users of consumer electronic devices are used to selecting from a list of options to control their device and expect such a ‘layback’ experience when watching content.

According to a further embodiment of the present invention, the controller is further configured for: recognizing a plurality of objects in the image being played back and obtaining a keyword associated to each of the recognized objects. In this way, the viewer may easily select for which one of a plurality of objects in the image, he wishes to retrieve more information. The controller may be further configured for indicating (highlighting) the object in the image associated to a highlighted keyword. In this way, it is shown to the viewer to which one of the objects (for example actors) a highlighted keyword belongs. This is particularly useful for users that have no or little knowledge about the objects in the image.

Furthermore, the controller may be configured for obtaining one or more keywords associated to a program of which the image being played back is part. For example, the title of the program may be included in the lists of keywords or texts in the image. As a result, the viewer is provided with further useful keywords from which he may select.

According to a still further embodiment, the controller is further configured for downloading image data of objects in images of a program based on preliminary information about the program, for example the program title. By downloading the image data before the object recognition starts, the object recognition step may be performed locally in the playback apparatus without the need to inquire a server for the image data, which would result in a time delay.

The image data may comprise multiple albums for at least one of the objects. This results in an improved reliability of the object recognition.

In case that the images that are played back are video frames of a video, the controller may be configured for displaying the information retrieved based on the keyword and pausing the video when displaying the information. In this way the viewer can check the information without missing anything of the content he is watching.

According to a further aspect of the invention, a method is provided comprising the steps of:
playing back images;
recognizing an object in an image being played back;
obtaining a keyword associated to the recognized object; and
searching for information based on the keyword.

Preferably, the method according to the invention is implemented by means of a computer program. The computer program may be embodied on a computer readable medium or a carrier medium may carry the computer program.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows a snapshot of a prior art functionality for providing information during playback of content.

FIG. 2 shows a block diagram of a playback apparatus wherein the present invention can be implemented.

FIG. 3 shows a flowchart of searching information associated to objects in an image being played back according to an exemplary embodiment of the invention.

FIG. 4 shows the display of a menu with suggested keywords over the image according to an exemplary embodiment of the invention in case that there is one recognized object in the image.

FIG. 5 shows the display of the menu over the image in case that there is a plurality of recognized objects in the image.

FIG. 6 shows the display of FIG. 5, wherein one of the keywords and the corresponding object are highlighted.

FIG. 7 shows the display of FIG. 5, wherein another one of the keywords and the corresponding object are highlighted.

FIG. 8 shows the display of retrieved information associated with one of the objects over the image.

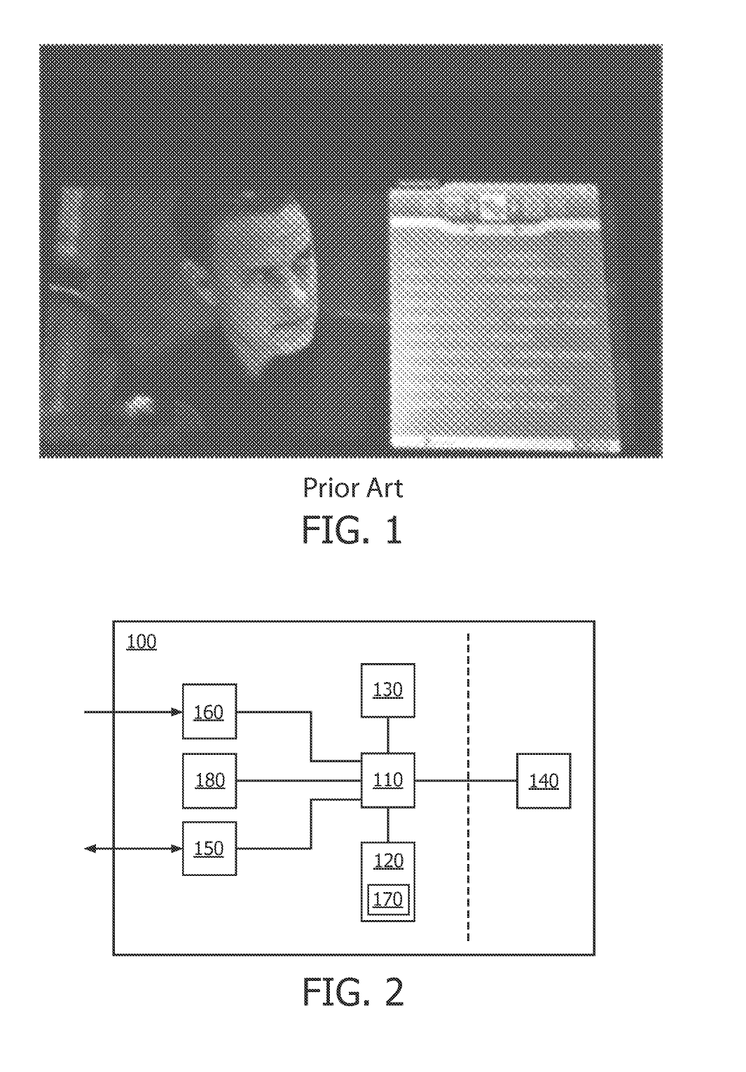

Throughout the figures like reference numerals refer to like elements.

### DETAILED DESCRIPTION OF THE PRESENT INVENTION

FIG. 2 shows a block diagram of an exemplary playback apparatus 100, for example a TV with internet access, wherein the present invention may be implemented. Only those features relevant for understanding the present invention are shown. The apparatus comprises a controller (processor) 110 with an associated memory 120, a display (e.g. a TV screen) 130, an input device 140 (which may be a remote control) enabling the viewer to provide input commands, and an interface unit 150, such as a router or modem for connection to the Internet. It furthermore comprises a functionality 160 related to receiving TV-programs, e.g. from a cable TV-network or from a DVB network and a memory 180 with a larger capacity.

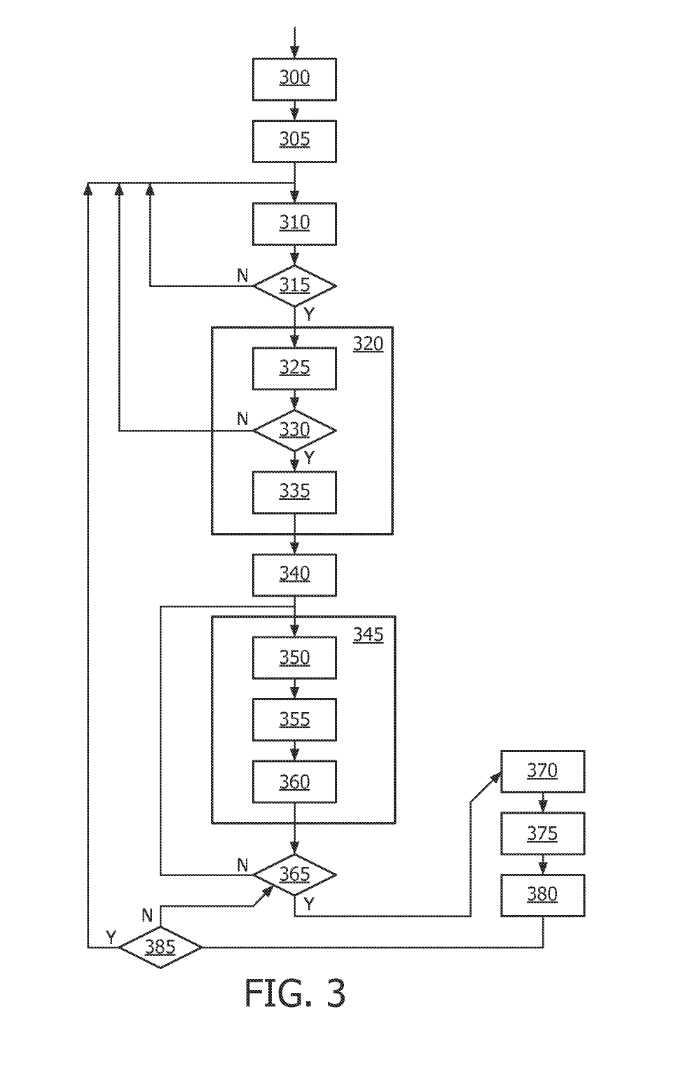

The functionality, which will be shown with reference to FIG. 3 herein after is preferably implemented by means of a suitable computer program 170 loaded to the associated memory 120 of the processor 110.

As shown in FIG. 3, the viewer first selects a program (for example a movie) for watching (step 300) with his remote control 140. On the side of the playback apparatus, at the start of a video playback, information about the movie is gathered (step 305). This information may be downloaded from a remote server over the playback apparatus' (client's) Internet connection. Information gathered includes but is not limited to the title of the movie, the filename, metadata, titles and other information from DVB-T program information, streaming video, etc.

To recognize a face of an actor starring in the movie, a minimum of one face album is required. However, multiple face albums of the same face increase the detection and recognition accuracy. Each of the face albums contains information to recognize a face.

The server holds a database containing albums of faces, and the associated metadata pertaining to the faces. The includes but not limited to title of shows, other actors/actresses, other shows that the actors acted in, genre, etc. Also the face album and the associated metadata pertaining to the faces are downloaded from the server(s) in step 305 and stored in the local memory 180. For example, based on the title of the movie, the albums of faces related to the movie are retrieved and downloaded into the local memory of the playback apparatus.

In the meantime the playback apparatus starts playing back the movie (step 310). It is now checked if, while watching the video, the user presses a designated ‘get information’ key on the remote control 140 (step 315). If this the case, the currently rendered video frame is analyzed (step 320). This analysis contains the substeps of detecting if there are any faces in the video frame (sub step 325). This may be performed by means of a face detection algorithm. Such algorithms are well known, see for a technical overview and explanation of existing algorithms, for example http://en.wikipedia.org/wiki/Face_detection or the article Face Detection Technical Overview: which can be retrieved at http://www.google.com.sg/search?q=face+detection+algorithm&ie=utf-8&oe=utf−8&aq=t&rls=org.mozilla:en-US:official&client=firefox-a.

If there are any faces in the video frame (checked in sub step 330), the video frame is processed by a face recognition algorithm known as such based on the album faces downloaded (sub step 335). A technical explanation of face recognition is found on http://en.wikipedia.org/wiki/Facial_recognition_{—} system and http://www.biometrics.gov/Documents/FaceRec.pdf. On top of that, it is possible to recognize also other texts in the video frame by means of a text detection engine in the apparatus. Text detection engines are well known, see for a technical explanation of text detection http://en.wikipedia.org/wiki/Optical_character_recognition or the Technical paper: Tappert, Charles C., et al (1990-08), The State of the Art in On-line Handwriting Recognition, IEEE Transactions on Pattern Analysis and Machine Intelligence, Vol 12 No 8, August 1990, pp 787-ff, http://users.erols.com/rwservices/pens/biblio90.html#Tappert90c. Then, the keywords associated to the recognized objects are obtained (step 340). The keywords are for example the names of the actors.

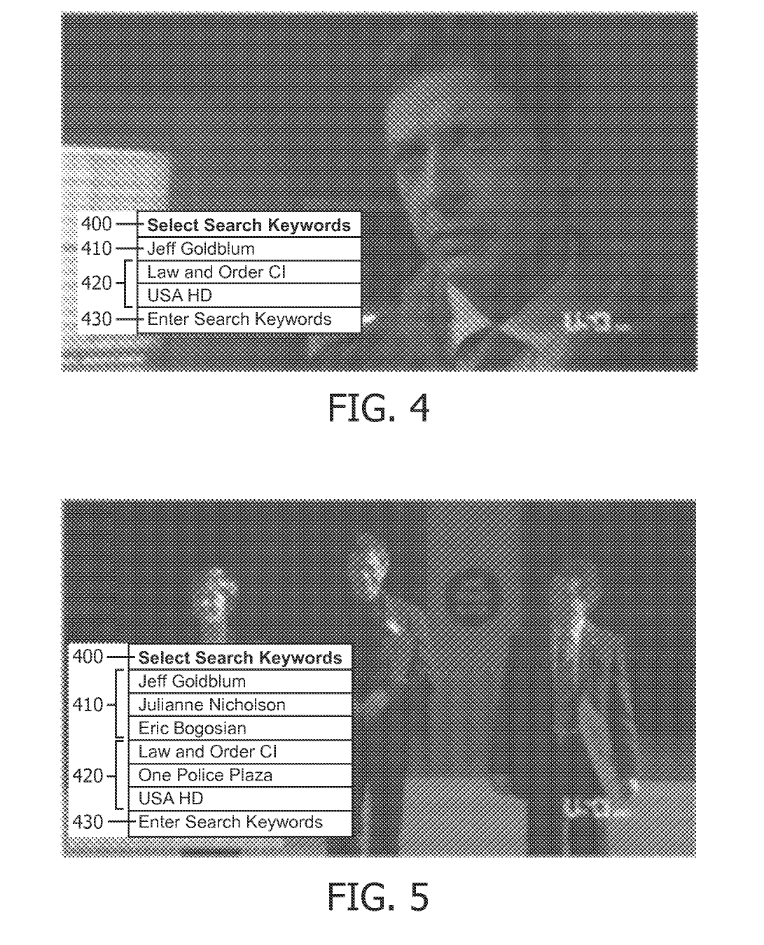

Next, the viewer is enabled to select one of the keywords for searching (step 345). This step comprises the sub steps of displaying keywords associated to the detected faces and other information associated to the movie (e.g. video/movie title, scenery information, etc) (sub step 350) in a menu list 400 as shown in FIG. 4. In FIG. 4 the menu list is shown in case that there is only one face (actor) in the analyzed video frame. There is a single keyword 410 (the name of the actor) in the menu associated to the actor and there are other keywords 420. These other keywords may be associated to a program of which the image being played back is part, for example its title or they may be other texts detected in the video frame by the text detection engine. In FIG. 5 the menu list is shown in case that there are three actors in the analyzed video frame. In this case, the menu list is populated with three keywords 410, each of them associated with one of the three actors.

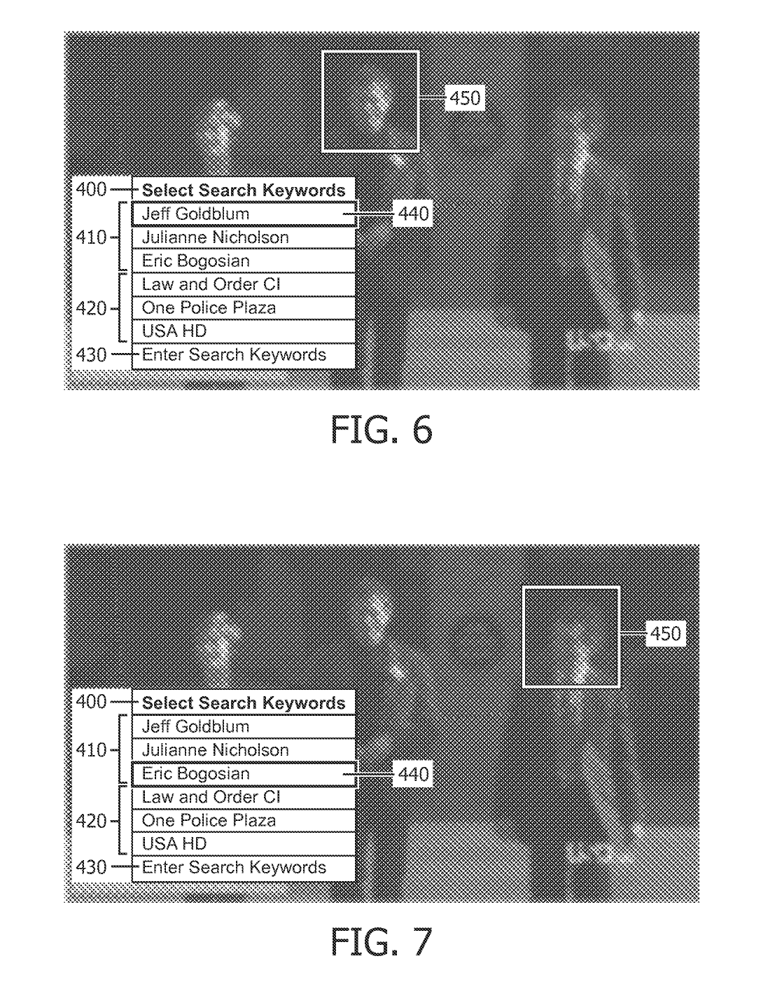

Now, the user is enabled to scroll through the menu list (sub step 355), the keyword corresponding to the scrolling position is highlighted 440, as shown in FIG. 6. The face of the actor corresponding to the highlighted keyword is also highlighted 450 (sub step 360) for example with a red box. As shown in FIG. 7, when the user scrolls to a different keyword, that keyword and the face of the corresponding actor are highlighted. The scrolling through the menu and the subsequent selection of a keyword are performed by means of appropriate keys (for example, up, down and OK) of the remote control 140. A last option 430 of the menu enables the user to key in the words that are not in the menu list.

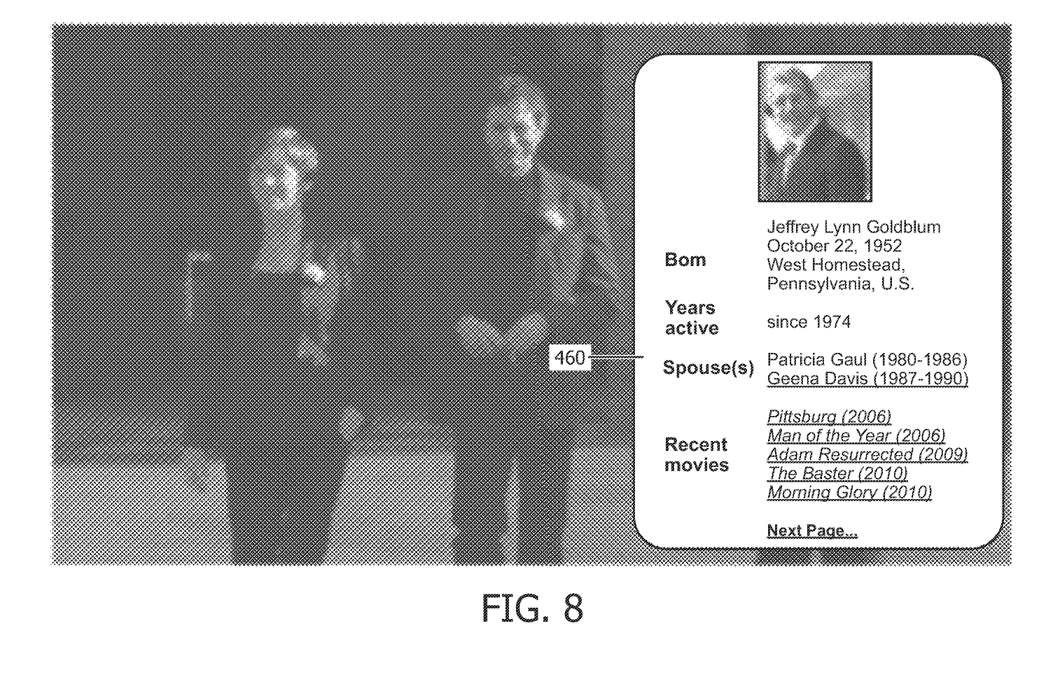

In case that the user selects a keyword as checked in step 365, a search is performed based on the keyword (step 370). This search may be in locally stored metadata related to the faces of the face albums in the playback apparatus 100 or it may be an Internet search using an Internet search engine, known as such. The movie is paused (step 375) and the information retrieved by the search is displayed over the image (step 380) as shown in FIG. 8. When the user presses a key in the remote control to continue the playback of the video (as checked in step 385), the flow loops back to step 310 and the playback is continued.

While the invention has been illustrated and described in detail in the drawings and foregoing description, such illustration and description are to be considered illustrative or exemplary and not restrictive; the invention is not limited to the disclosed embodiments.

In this regard it is to be noted that the communication link between the playback apparatus and the server may be through other means than the Internet.

Furthermore, the invention can be implemented for other kinds of objects than actors in a movie, either human objects for example TV presenters, sports people, etc. or non-human objects, such as new mobile phone, a diamond ring, etc. In this case, instead of face detection/recognition, an object recognition algorithm can be used. The system may show a link to the website with information about the objects.

Of course, it is also possible to continue playing back the video when the information is displayed and not pausing it.

The invention may also be applied to still images and not only to moving video.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Playback apparatus for playing back images in a program, the apparatus comprising a controller configured for executing the steps of:
downloading image data of objects in images of the program based on preliminary information about the program;
recognizing an object in an image being played back based on the downloaded image data;
obtaining a keyword associated to the recognized object; and
searching for information based on the keyword.

2. Playback apparatus as claimed in claim 1, wherein the controller is further configured for:
obtaining a plurality of keywords; and
enabling a user to select one of the keywords for searching.

3. Playback apparatus as claimed in claim 2, wherein the controller is further configured for:
recognizing a plurality of objects in the image being played back; and
obtaining the plurality of keywords by obtaining a keyword associated to each of the recognized objects.

4. Playback apparatus as claimed in claim 3, wherein the controller is further configured for:
indicating the object in the image associated to a highlighted keyword.

5. Playback apparatus as claimed in claim 2, wherein the controller is further configured for:
obtaining one or more keywords associated to a program of which the image being played back is part.

6. (canceled)

7. Playback apparatus as claimed in claim 1, wherein the image data comprises multiple albums for at least one of the objects, each album containing information to recognize a face.

8. Playback apparatus as claimed in claim 1, wherein the images that are played back are part of a video and wherein the controller is configured for:
displaying the information retrieved based on the keyword; and
pausing the video when displaying the information.

9. Method comprising the steps of:
downloading image data of objects in images of a program based on preliminary information about the program,
playing back images from the program;
recognizing an object in an image being played back based on the downloaded image data;
obtaining a keyword associated to the recognized object; and searching for information based on the keyword.

10. A computer program comprising computer program code means adapted to perform the steps of the method according to claim 8 when said program is run on a computer, a digital signal processor, a field-programmable gate array, an application-specific integrated circuit, a micro-processor, a micro-controller, or any other form of programmable hardware.
